(19) United States
(12) Patent Application Publication
(10) Pub. No.: US 2010/0265436 A1
(43) Pub. Date: Oct. 21, 2010

(54) LIQUID CRYSTAL DISPLAY AND METHOD OF MANUFACTURING LIQUID CRYSTAL DISPLAY

(75) Inventor: Hiromi SAITO, Chino (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Shinjuku-ku (JP)

(21) Appl. No.: 12/752,492

(22) Filed: Apr. 1, 2010

(30) Foreign Application Priority Data
Apr. 20, 2009 (JP) 2009-101988

(51) Int. Cl. G02F 1/1335; G02F 1/1339

(52) U.S. Cl. 349/96; 445/25; 349/190; 349/120

(57) ABSTRACT

There are provided a liquid crystal layer; a plurality of colorant parts disposed so as to be divided for each of a plurality of pixel areas, and having mutually different wavelengths for transmitted light; a polarizing layer disposed on the light-emitting side of the liquid crystal layer; and a plurality of phase difference members disposed on the light-admitting side of the polarizing layer and disposed so as to be divided for each of the plurality of pixel areas. With each of the plurality of phase difference members, at least one of birefringence and thickness is varied for the plurality of phase difference members to adjust the retardation value so that, of the light that is incident on the polarizing layer, the polarization state of light whose wavelength allows the light to be transmitted by the colorant parts that correspond to the phase difference members is brought closer to that of linearly polarized light that oscillates in a designated direction.

### CROSS-REFERENCE TO RELATED APPLICATIONS

The entire disclosure of Japanese Patent Application No. 2009-101988, filed Apr. 20, 2009 is expressly incorporated by reference herein.

### BACKGROUND

1. Technical Field

The present invention relates to a liquid crystal display and to a method of manufacturing a liquid crystal display.

2. Related Art

Displays in which a liquid crystal layer is sealed between a color filter substrate (abbreviated as a “CF substrate” hereinbelow) and an element substrate are conventionally known as liquid crystal displays (see, for example, the specification of Japanese Patent No. 3261854). The element substrate allows an electric field to be applied to the liquid crystal layer in every pixel area. A case will be described below in which the liquid crystal layer has a TN orientation. The liquid crystal layer is sandwiched between an incident-side polarizing plate and an emission-side polarizing plate. The incident-side polarizing plate and emission-side polarizing plate may, for example, be arranged so that the transmission axes thereof are orthogonal to each other. The incident-side polarizing plate and emission-side polarizing plate are adapted to pass linearly polarized light.

The phase difference (amount of phase modulation) generated in the two-directional oscillations of light incident on the liquid crystal layer is determined by the retardation value of the liquid crystal layer and the wavelength of the incident light. The retardation value is determined by the thickness of the liquid crystal layer and the differences between the refractive indices (birefringence) in the two directions. With a TN-oriented liquid crystal layer, the phase difference changes when no electric field is applied, and the phase difference does not change when an eclectic field is applied.

Light that has passed through the incident-side polarizing plate becomes linearly polarized light and is incident on the liquid crystal layer. The light that is incident on the liquid crystal layer when no voltage is applied is modulated in phase in the liquid crystal layer and, ideally, is converted to light linearly polarized in a direction orthogonal to the direction of incident light. A bright display (normally white) is obtained in the absence of an applied electric field by passing the linearly polarized light through the incident-side polarizing plate. Because no phase modulation occurs in light that is incident on the liquid crystal layer when no voltage is applied, the linearly polarized light is emitted unmodified without any changes in the polarized state. A dark display is yielded in the presence of an applied electric field by the absorption of the linearly polarized light in the emission-side polarizing plate.

The CF substrate is composed of a plurality of colorant parts in which transmitted light has different wavelengths. The colorant parts have a one-to-one correspondence with the pixel areas. For example, a single pixel of a full-color image is formed by light emitted by three pixel areas, that is, red, green, and blue pixel areas.

It is sometimes difficult to change the polarization direction by exactly 90° solely by the phase modulation action of the liquid crystal layer. If the light incident on the emission-side polarizing plate is elliptically polarized light, this light cannot be adequately turned on or off by the emission-side polarizing plate, resulting in reduced contrast, undesirable coloration, and other problems. It is preferable to place an optical compensation sheet such as the one described, for example, in JP-A 2006-293099 between the liquid crystal layer and the emission-side polarizing plate in order to convert elliptically polarized light to linearly polarized light.

Such conventional liquid crystal displays need to be improved in terms of image quality. Appropriately setting the amount of phase modulation is effective for obtaining better image quality. However, the amount of phase modulation has wavelength dependency and varies with the wavelength of incident light, making it difficult to optimize the retardation value. For example, optimizing the retardation value for any of the colors red, green, and blue (e.g., green) makes it impossible to optimize the retardation value for the other two colors (red and blue). Specifically, light that has passed through the portions of the liquid crystal layer which correspond to red and blue pixel areas is elliptically polarized light, and the quantity of light absorbed by the emission-side polarizing plate is no longer the desired value. The red and blue gradation is therefore no longer at the desired level. Using an optical compensation film, for example, has been suggested as a method of overcoming this problem. Ordinarily, however, an optical compensation film is shared by a plurality of pixel areas and is often formed integrally with the emission-side polarizing plate, making it difficult to adjust the characteristics for each of the pixel areas.

### SUMMARY

The present invention was devised in view of the above-described situation and has as an object thereof providing a liquid crystal display capable of displaying high-quality images. Another object is to provide a method whereby a liquid crystal display capable of yielding high-quality images can be manufactured with high efficiency.

### Means For Attaining the Aforementioned Objects

The liquid crystal display of the present invention is characterized in having a liquid crystal layer; a plurality of colorant parts disposed at a position of incidence of light that has passed through the liquid crystal layer, the parts being disposed so as to be divided for each of a plurality of pixel areas, and having mutually different wavelengths for transmitted light; a polarizing layer disposed on the light-emitting side of the liquid crystal layer; and a plurality of phase difference members disposed on the light-admitting side of the polarizing layer and disposed so as to be divided for each of the plurality of pixel areas, wherein, with each of the plurality of phase difference members, at least one of birefringence and thickness is varied for the plurality of phase difference members to adjust the retardation value so that, of light that is incident on the polarizing layer, the polarization state of light whose wavelength allows the light to be transmitted by the colorant parts that correspond to the phase difference members is brought closer to that of linearly polarized light that oscillates in a designated direction.

The retardation value is thus adjusted by each of the phase difference members so as to obtain linearly polarized light from light whose wavelength allows the light to be transmitted by colorant parts that correspond to the phase difference members, i.e., display-contributing light, in the light that is incident on the polarizing layer. It is therefore possible to convert light that has passed through the polarizing layer into high-brightness light, i.e., light having the desired gradation. It is therefore possible to obtain a liquid crystal display in which each of a plurality of beams of colored light that has passed through a plurality of colorant parts has high brightness and the desired gradation, and a high-quality image can be displayed.

In addition, it is preferable that partition walls for annularly enclosing each of the plurality of pixel areas be provided between the plurality of colorant parts, and the plurality of phase difference members be disposed so as to be divided in the plurality of pixel areas enclosed by the partition walls. In this case, it is preferable that the plurality of colorant parts and the plurality of phase difference members be formed by a droplet discharge method.

It is thus possible to partition the plurality of colorant parts by using the partition walls, and to partition the plurality of phase difference members by using the partition walls. High precision can be achieved for the relative position of the colorant parts and the phase difference members because of the sharing of the partition walls for partitioning the colorant parts and of the partition walls for partitioning the phase difference members that correspond to the colorant parts. In addition, very high precision can be obtained for the relative position of the plurality of colorant parts and the plurality of phase difference members because forming the colorant parts and the phase difference members by a droplet discharge method allows the material for forming the colorant parts and the material for forming the phase difference members to be arranged with high precision in the plurality of pixel areas enclosed by the partition walls. Furthermore, the droplet discharge method allows the plurality of colorant parts and the plurality of phase difference members to be formed at a lower cost, and the cost of manufacturing the image display to be reduced.

In addition, the thickness of the plurality of phase difference members may vary with the phase difference members, and the thickness of the liquid crystal layer may be adjusted for each of the plurality of pixel areas by using the differences in thickness between the plurality of phase difference members.

The retardation value of the liquid crystal layer can thus be adjusted for each of the pixel areas, and the amount of phase modulation of light that is incident on the liquid crystal layer can be adjusted for each of the pixel areas. The polarization state of light that is incident on the polarizing layer can thereby be adjusted using the liquid crystal layer in addition to the plurality of phase difference members so that a plurality of beams of display-contributing colored light is converted to linearly polarized light. A multigap can thus be constructed using the differences in thickness between the phase difference members, and there is little need to separately provide the constituent elements for constructing the multigap, for which reason an image display can be easily constructed.

The method of manufacturing a liquid crystal display according to the present invention is a method of manufacturing a liquid crystal display having a liquid crystal layer sandwiched between a first substrate and a second substrate, a polarizing layer provided on the light-emitting side of the liquid crystal layer, and a plurality of pixel areas for emitting light of different wavelengths, the method characterized in comprising a step for forming the first substrate, a step for forming the second substrate, and a step for bonding the first substrate and the second substrate together and sealing the liquid crystal layer between the first substrate and the second substrate; wherein the step for forming the second substrate includes a step for forming partition walls for annularly enclosing each of the plurality of pixel areas on the substrate, a step for forming a plurality of colorant parts for which the wavelengths of transmitted light are different from each other by a droplet discharge method in each of the plurality of pixel areas enclosed by the partition walls, and a step for discharging a liquid material for forming phase difference members by the droplet discharge method in each of the plurality of pixel areas enclosed by the partition walls and varying at least one of the discharge rate and the material for forming phase difference members in the plurality of pixel areas to form a plurality of phase difference members having mutually different retardation values; and wherein the retardation values of the plurality of phase difference members are adjusted in the step for forming the phase difference members so that, of the light that is incident on the polarizing layer, the polarization state of light whose wavelength allows the light to be transmitted by the colorant parts that correspond to the phase difference members is brought closer to that of linearly polarized light that oscillates in a designated direction.

It is thus possible to manufacture a liquid display capable of yielding high-quality images. Because a plurality of colorant parts and a plurality of phase difference members are formed as patterns by a droplet discharge method, the discharge rate and the type of material for forming colorant parts or material for forming phase difference members can be more easily varied for a plurality of pixel areas, and the second substrate can be formed at a low cost and with high efficiency. High precision can be achieved for the relative position of the colorant parts and the phase difference members because partition walls for enclosing each of a plurality of pixel areas are formed, and the material for forming colorant parts and the material for forming phase difference members are discharged into the pixel areas enclosed by the partition walls. In addition the first substrate can be manufactured in the same manner as an ordinary liquid crystal display, dispensing with the need for the processing devices not used in the manufacture of ordinary first substrates, and thereby making it possible to reduce the manufacturing costs.

According to the present invention, a liquid crystal display capable of yielding high-quality images can thus be manufactured at a low cost and with high efficiency.

### BRIEF DESCRIPTION OF THE DRAWINGS

FIG. 1 shows a schematic structure of a liquid crystal display, wherein (a) is a perspective view, and (b) is an enlarged view;

FIG. 2 is a partial cross-sectional view of the liquid crystal display;

FIGS. 3(a) to (c) are explanatory views showing a method of adjusting the retardation value;

FIGS. 4(a) to (c) are cross-sectional process diagrams showing the method of manufacturing a liquid crystal display;

FIGS. 5(a) to (c) are cross-sectional process diagrams that continue from FIG. 4(c); and

FIGS. 6(a) and (b) are cross-sectional process diagrams that continue from FIG. 5(c).

### DETAILED DESCRIPTION OF EXEMPLARY EMBODIMENTS

Embodiments of the present invention are described below with reference to the accompanying drawings. The dimensions and scale of the structures in the drawings, which are used for purposes of explanation, at times may be different from the actual structures in order to show the pertinent parts in a clearly understandable manner. The same structural elements in the embodiments are shown by the same reference numbers, and a detailed description thereof may be omitted.

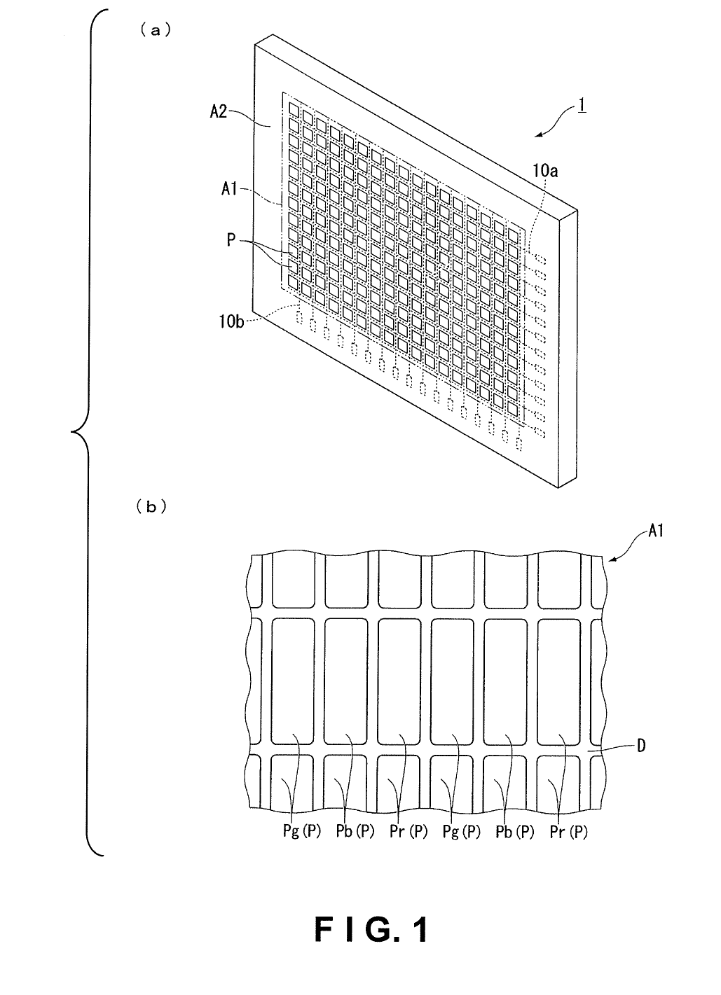

FIG. 1(a) is a perspective view showing in outline a schematic structure of the liquid crystal display 1 according to the present invention. FIG. 1(b) is a plan view showing a display area in enlarged form. The liquid crystal display 1 is substantially plate-shaped and has a display area Al on one surface thereof, as shown in FIG. 1(a). A plurality of pixel areas P is disposed in a matrix in the display area A1. The exterior of the display area A1 is a frame A2. A plurality of scanning lines 10a and a plurality of data lines 10b are provided inside the liquid crystal display 1. The plurality of scanning lines 10a are substantially parallel to each other, and the plurality of data lines 10b are also substantially parallel to one another. The scanning lines 10a and the data lines 10b are substantially orthogonal to each other (intersect each other). The areas enclosed by the scanning lines 10a and the data lines 10b are the pixel areas P.

The scanning lines 10a and the data lines 10b are provided across the display area A1 and the frame A2. The end parts of the scanning lines 10a in the frame A2 are electrically connected to a scanning line drive circuit (not shown) for supplying scanning signals. The end parts of the data lines 10b in the frame A2 are electrically connected to a data line drive circuit (not shown) for supplying image signals.

The display area A1 includes a pixel area Pr for red display, a pixel area Pg for green display, and a pixel area Pb for blue display as the pixel areas P, as shown in FIG. 1(b). Red light, green light, and blue light are emitted respectively from the pixel areas Pr, Pg, Pb toward the display. The red light, green light, and blue light are blended and made visible, and a single pixel of a full color image is displayed. There are light-blocking areas D between the pixel areas Pr, Pg, Pb.

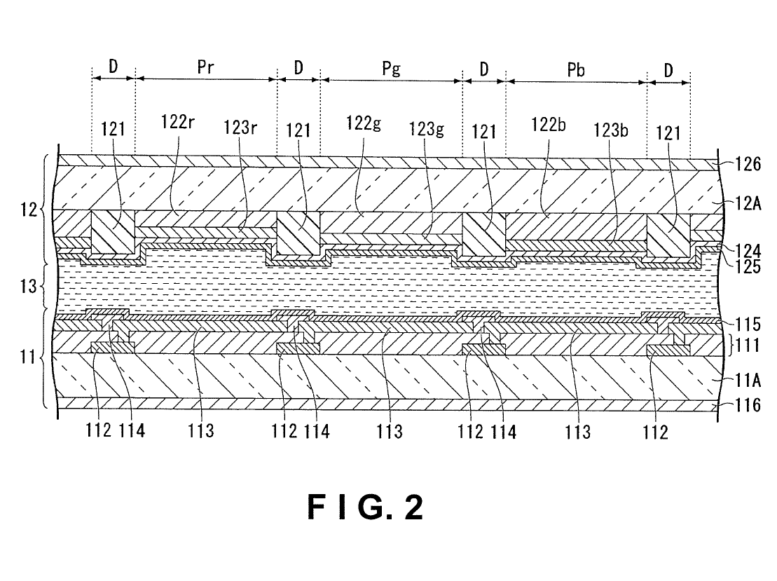

FIG. 2 is a partial cross-sectional view of the liquid crystal display 1. The liquid crystal display 1 has an element substrate (first substrate) 11, a CF substrate (second substrate) 12 disposed facing the element substrate 11, and a liquid crystal layer 13 sandwiched between the element substrate 11 and the CF substrate 12, as shown in FIG. 2.

The element substrate 11 is, for example, an active matrix substrate, and has as a base a transparent substrate 11A made from glass, quartz, plastic, or the like. An element layer 111 is provided on the transparent substrate 11A. The element layer 111 is provided with thin-film transistors (TFTs) 112, the scanning lines 10a and data lines 10b shown in FIG. 1(a), and other wiring elements. The TFTs 112 and the wiring elements are provided to a portion superposed on the light-blocking areas D.

Island-shaped pixel electrodes 113 are formed for each of the pixel areas Pr, Pg, Pb on the side of the element layer 111 facing the liquid crystal layer 13. The pixel electrodes 113 have a one-to-one correspondence with the TFTs 112, and are each electrically connected to their corresponding TFTs 112. The TFTs 112 switch the image signals on the basis of the scanning signals, and feed the image signals to the pixel electrodes 113 at a predetermined timing.

A passivation film 114 made from, for example, silicon oxide or another inorganic material is provided on the portions of the element layer 111 superposed on the light-blocking areas D. The passivation film 114 covers the circumferential edge parts of the pixel electrodes 113 in an annular shape, and is formed along the circumferential edge parts of the plurality of pixel electrodes 113. A first orientation film 115 is provided between the pixel electrodes 113 and the liquid crystal layer 13. The first orientation film 115 is a film made from, for example, polyimide or another appropriate material that has been subjected to a rubbing treatment or another orientation treatment, and, together with a second orientation film 125 (described below), controls the orientation state of the liquid crystal layer 13. Here, an orientation treatment is performed on the first orientation film 115 and the second orientation film 125 so as to cause the liquid crystal layer 13 to have a twisted nematic orientation (TN orientation).

The side opposite from the liquid crystal layer 13 on the transparent substrate 11A of the liquid crystal display 1 of the present embodiment is the side that receives the illuminating light. The transparent substrate 11A is provided with a first polarizing plate 116 on the side that receives the illuminating light. The first polarizing plate 116 has the characteristic of passing linearly polarized light in a predetermined direction. An illumination device (backlight; not shown) composed of a light source, a light guiding plate, or the like is disposed on the side of the first polarizing plate 116 opposite to the liquid crystal layer 13.

In the CF substrate 12, a transparent substrate 12A made from glass, quartz, plastic, or the like is made into a base. Partition walls 121 are provided to the portions of the transparent substrate 12A on the side of the liquid crystal layer 13 superposed on the light-blocking areas D. The partition walls 121 are provided with openings in the portions superposed on the pixel areas Pr, Pg, Pb. Specifically, the partition walls 121 annularly enclose the pixel areas Pr, Pg, Pb. The partition walls 121 are made from, for example, acrylic resin or another material containing black pigment or another light-blocking material, and function as a black matrix.

Phase difference members 122r, 122g, 122b are disposed so as to be divided in the portions of the transparent substrate 12A superposed on the pixel areas Pr, Pg, Pb on the side of the liquid crystal layer 13. The phase difference members 122r, 122g, 122b are disposed inside each of the plurality of openings provided to the partition walls 121, and are partitioned by the partition walls 121. An optical compensation layer is constructed from the phase difference members 122r, 122g, 122b. The optical compensation layer adjusts the retardation value (δn·d) for each of the phase difference members 122r, 122g, 122b by causing the birefringence (δn) and the thickness (d) to differ in the phase difference members 122r, 122g, 122b. One axis of the refractive index anisotropy of the optical compensation layer is substantially parallel to the transmission axis of the first polarizing plate 116.

Colorant parts 123r, 123g, 123b are disposed so as to be divided in the portions of the optical compensation layer superposed on the pixel areas Pr, Pg, Pb on the side of the liquid crystal layer 13. The colorant parts 123r, 123g, 123b are disposed inside each of the plurality of openings provided to the partition walls 121, and are partitioned by the partition walls 121. The colorant parts 123r, 123g, 123b have the characteristic of transmitting red light, green light, and blue light, respectively, and absorbing the colored light of other wavelength bands. A color filter layer is constructed from the colorant parts 123r, 123g, 123b.

A shared electrode 124 is provided to the color filter layer on the side of the liquid crystal layer 13. The second orientation film 125 is provided to the shared electrode 124 on the side of the liquid crystal layer 13. A second polarizing plate (polarizing layer) 126 is disposed on the side of the transparent substrate 12A opposite the liquid crystal layer 13. The second polarizing plate 126 has the characteristic of passing linearly polarized light. Here, the transmission axis of the second polarizing plate 126 is at an angle of about 90° in relation to the transmission axis of the first polarizing plate 116. The shared electrode 124, the second orientation film 125, and the second polarizing plate 126 are each provided in a common arrangement and in a substantially continuous formation to the pixel areas Pr, Pg, Pb. The second orientation film 125 has differences in level between the portions superposed on the pixel areas Pr, Pg, Pb, which arise from the differences in thickness between the phase difference members 122r, 122g, 122b.

The liquid crystal layer 13 is composed of a liquid crystal material having birefringence. Here, the orientation state of the liquid crystal layer 13 is TN orientation, and the liquid crystal layer 13 exhibits birefringence in a state in which no electric field is applied. When an electric field is applied to the liquid crystal layer 13, the director of the liquid crystal molecules becomes substantially parallel to the direction of the electric field, and the liquid crystal layer 13 no longer exhibits birefringence. In the liquid crystal layer 13, the second orientation layer 125 has steps in the portions superposed on the pixel areas Pr, Pg, Pb, whereby the thicknesses is caused to differ for each of the pixel areas Pr, Pg, Pb. Specifically, adjusting the thicknesses of the phase difference members 122r, 122g, 122b independently of each other allows the retardation value of the liquid crystal layer 13 to be adjusted for each of the pixel areas Pr, Pg, Pb. Light that passes through the liquid crystal layer 13 and is incident upon the second polarizing plate 126 is modulated in phase in the liquid crystal layer 13 and the optical compensation layer and converted to a polarized state. The total amount of phase modulation in the liquid crystal layer 13 and the optical compensation layer is adjusted for each of the pixel areas Pr, Pg, Pb so as to obtain the optimal value for each of the plurality of colors (red, blue, green). The method for adjusting the amount of phase modulation is described below.

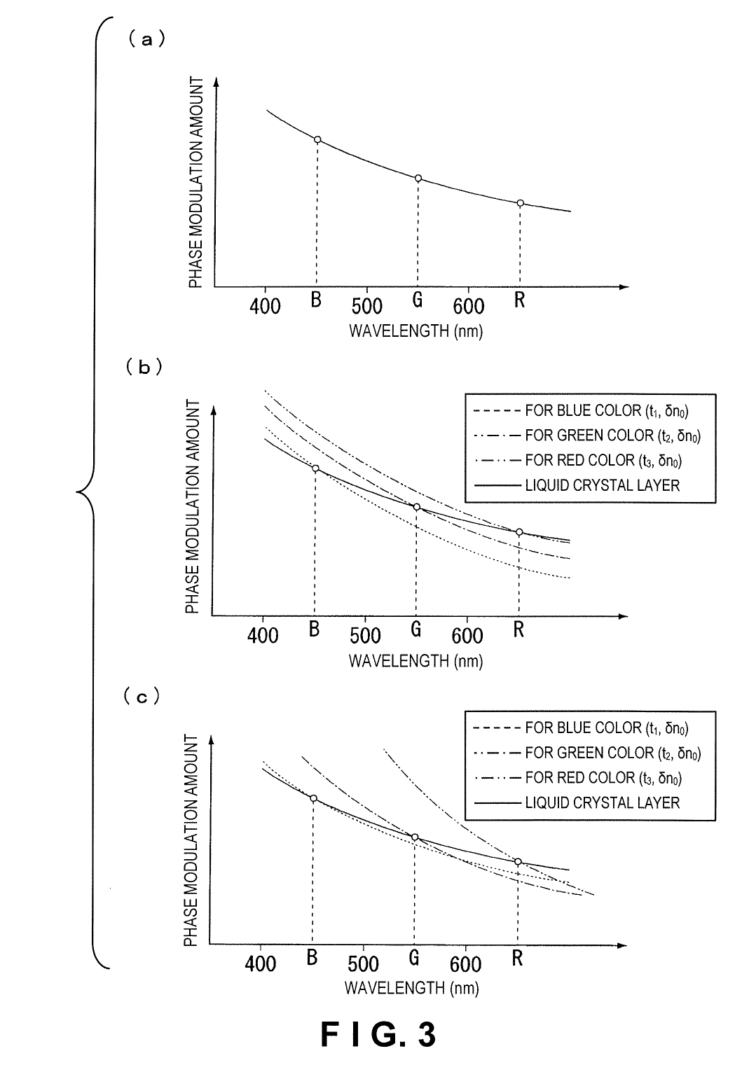

FIG. 3(a) is a graph showing the wavelength dependence of the amount of phase modulation in a liquid crystal layer having a fixed thickness. FIG. 3(b) is a graph showing the amount of phase modulation of the phase difference members in relation to a change in thickness of the phase difference members. FIG. 3(c) is a graph showing the amount of phase modulation of the phase difference members in a case in which different materials are used for the phase difference members. In FIGS. 3(b) and (c), the amount of phase modulation in the liquid crystal layer is shown in addition to the amount of phase modulation of the phase difference members.

The amount of phase modulation generally decreases as the wavelength of the incident light increases, as shown in FIG. 3(a). Specifically, the phase difference (amount of phase modulation) generated between an oscillating component in the direction of the first axis and an oscillating component in the direction of the second axis in the case of light having wavelength λ that has passed through the liquid crystal layer is expressed as (n1−n2)·d/λ, where n1 is the refractive index along the first axis of the refractive index anisotropy in the liquid crystal layer, n2 is the refractive index along the second axis, and d is the thickness of the liquid crystal layer. It can be seen from the equation that the amount of phase modulation decreases in inverse proportion to the wavelength λ. The difference between the refractive indices (n1−n2) is the birefringence (δn) of the liquid crystal layer, and (n1−n2)·d is the retardation value of the liquid crystal layer.

Considered below as an example is a case in which the first axis is orthogonal to the second axis, and the light incident on the liquid crystal layer is linearly polarized light (referred to as first linearly polarized light). When the direction of oscillation of the linearly polarized light is at an angle of 45° to the first axis, and the amount of phase modulation expressed using a whole integer m is (2m+1)π, the light that has passed through the liquid crystal layer becomes second linearly polarized light whose direction of oscillation is rotated 90° in relation to the incident beam. When the amount of phase modulation is an amount other than 2mπ or (2m+1)π, the light that has passed through the liquid crystal layer becomes elliptically polarized light. Accordingly, in a case in which, for example, the incident light is white light, the blue and red light contained in the incident light become elliptically polarized light when the amount of phase modulation of the liquid crystal layer is set so that the green light contained in the incident light is converted to the second linearly polarized light.

The retardation value of the liquid crystal layer increases with increased thickness of the liquid crystal layer, but the value of the voltage necessary in order to apply the predetermined electric field to the liquid crystal layer also increases. The drive voltage of the liquid crystal layer is reduced, limitations are imposed on the liquid crystal material, and the field-of-view characteristics are improved. For these and other reasons, light that is incident on an emission-side polarizing plate can sometimes be converted to second linearly polarized light by the combined use of the liquid crystal layer and optical compensation layer. In such a case, the red light, green light, and blue light that have passed through the liquid crystal layer are each elliptically polarized light.

In the liquid crystal display 1, the retardation values of the phase difference members 122r, 122g, 122b are adjusted independently of each other so that, in the light that has passed through the liquid crystal layer 13, second linearly polarized light is obtained from each of the red light incident on the second polarizing plate 126 of the pixel area Pr, the green light incident on the second polarizing plate 126 of the pixel area Pg, and the blue light incident on the second polarizing plate 126 of the pixel area Pb.

The three methods given below can be considered as methods for adjusting the retardation value of each of the phase difference members. The first method is one in which the material (i.e., birefringence) of the phase difference members is kept the same for the colors red, green, and blue, while the thickness of the phase difference members is adjusted for each of the colors red, green, and blue. For example, the birefringence of the phase difference members for the colors red, green, and blue is kept the same (δn0), while the thickness of the phase difference members is increased (t1<t2<t3) in order from blue to green and red, as shown in FIG. 3(b). The retardation values of the phase difference members are thereby increased in order from blue to green and red, and the amount of phase modulation by the phase difference members can be adjusted for each of the pixel areas Pr, Pg, Pb.

The second method is one in which the thickness of the phase difference members is kept the same for the colors red, green, and blue, while the material used for the phase difference members is selected, allowing the birefringence to be independently adjusted for the colors red, green, and blue. The thickness of the phase difference members for the colors red, green, and blue is kept the same ((t0)), while the material of the phase difference members is selected for the colors red, green, and blue so that the birefringence increases (δn1<δn2<δn3) in order from blue to green and red, as shown in FIG. 3(c). The retardation values of the phase difference members thereby increases in order from blue to green and red, and the amount of phase modulation by the phase difference members can be adjusted for each of the pixel areas Pr, Pg, Pb.

The third method is one in which the material and the thickness of the phase difference members are both adjusted for each of the pixel areas Pr, Pg, Pb. In this method, there is greater latitude in selecting the material of the phase difference members, and the characteristics of the liquid crystal display can be improved by selecting the material for the phase difference members with consideration for durability and optical characteristics, for example. The third method is applied in the present embodiment, and the birefringence and thickness of the phase difference members 122r, 122g, 122b are independently adjusted for the pixel areas Pr, Pg, Pb.

The thickness of the liquid crystal layer 13 is adjusted for each of the pixel areas Pr, Pg, Pb using the differences in thickness between the phase difference members 122r, 122g, 122b. Specifically, the thickness of the liquid crystal layer 13 decreases in order from the pixel area Pb to the pixel area Pg and the pixel area Pb. The amount of phase modulation in the liquid crystal layer 13 is larger for the red light (pixel area Pr) and smaller for the blue light (pixel area Pb) than in a case where the thickness of the liquid crystal layer is uniform. The difference between the amount of phase modulation of the red light and the amount of phase modulation of the blue light can thereby be reduced, and the polarized state of the red, green, and blue light can be readily arranged in the second linearly polarized light.

In the liquid crystal display 1 thus configured, the illuminating light passes through the first polarizing plate 116, is converted to the first linearly polarized light, and is incident on the liquid crystal layer 13. With the pixel area Pr, for example, the liquid crystal layer 13 is in a state in which no electric field is applied, and exhibits birefringence when an image signal is not fed to the pixel electrode 113. Light incident on the liquid crystal layer 13 in a state in which no electric field is applied is phase modulated into elliptically polarized light, and is incident on the colorant part 123r. The light of wavelength bands other than red light in the light incident on the colorant part 123r is absorbed, and red light is emitted from the colorant part 123r. The red light emitted from the colorant part 123r passes through the phase difference member 122r and is thereby converted to the second linearly polarized light that is rotated 90° relative to the first linearly polarized light. The red light that has passed through the phase difference member 122r has a direction of oscillation that is substantially coincident with the transmission axis of the second polarizing plate 126, and passes through the second polarizing plate 126. The pixel area Pr is thereby made to yield a bright display (red).

The liquid crystal layer 13 is in a state in which an electric field is applied, and birefringence is not exhibited when an image signal is fed to the pixel electrode 113. The first linearly polarized light incident on the liquid layer 13 to which an electric field is applied is incident on the colorant part 123r without the polarization state being modified. The light of wavelength bands other than red light in the light incident on the colorant part 123r is absorbed, and red light is emitted from the colorant part 123r. The red light emitted from the colorant part 123r has a direction of oscillation that is substantially parallel to one of the axes of the refractive index anisotropy of the phase difference member 122r, and is therefore incident on, and absorbed by, the second polarizing plate 126 without being modulated in phase by the phase difference member 122r. The pixel area Pr is thereby made to yield a dark display (black).

The pixel areas Pg, Pb can also be switched between a bright display and a dark display depending on whether or not an electric field is applied, which is the same as with the pixel area Pr. For example, in a case in which the pixel areas Pr, Pg, Pb each produces a bright display, a single pixel constructed from the pixel areas Pr, Pg, Pb yields a white display. The liquid crystal display 1 can thus display a full color image. The liquid crystal display 1 can display a high-quality image because the retardation values are adjusted for each of the phase difference members 122r, 122g, 122b.

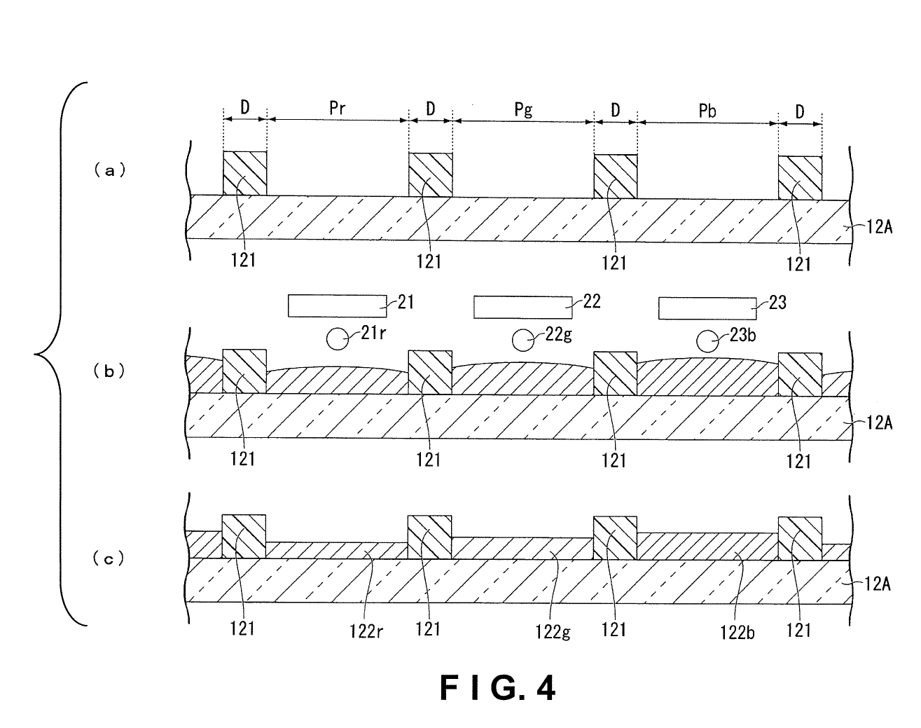

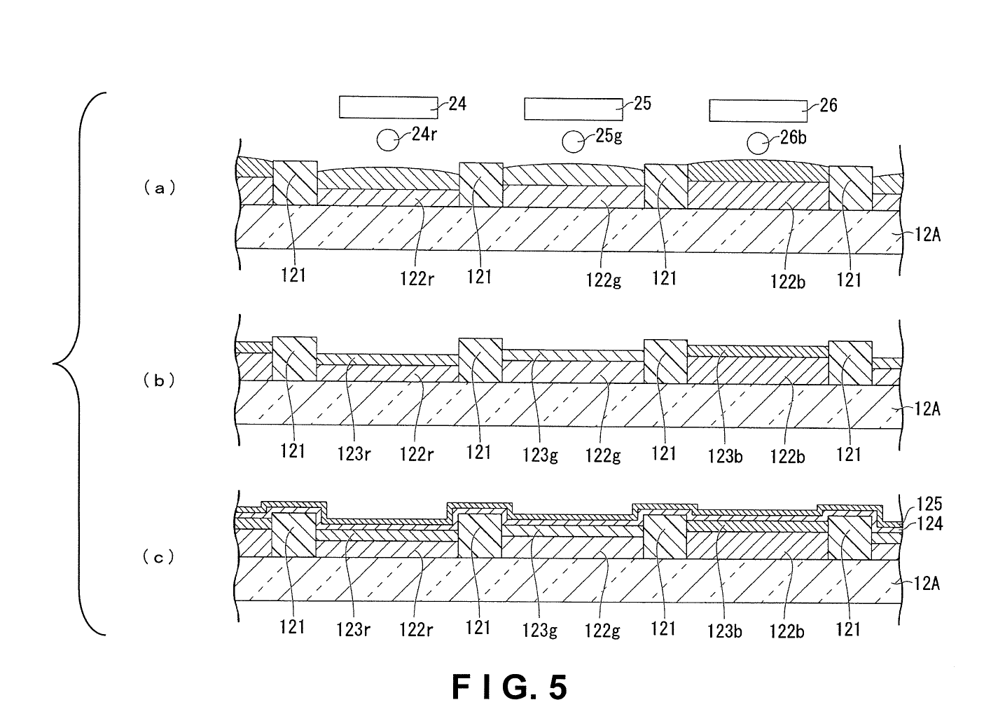

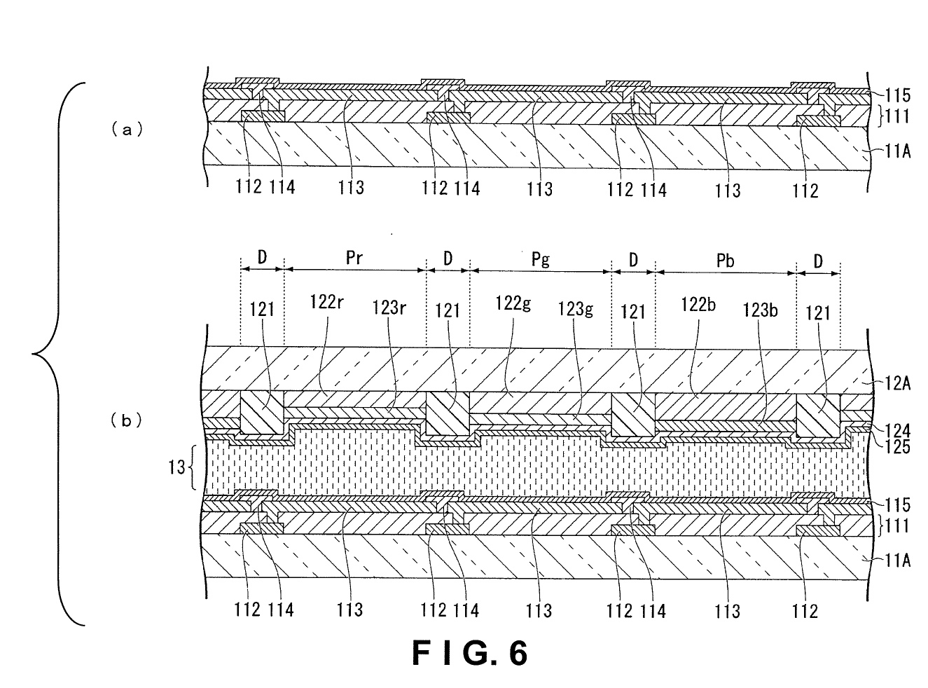

Next, an embodiment of the method of manufacturing a liquid crystal display according to the present invention will be described based on the structure of the liquid crystal display 1. FIGS. 4(a) to (c), FIGS. 5(a) to (c), and FIGS. 6(a), (b) are cross-sectional process diagrams schematically showing the method of manufacturing a liquid crystal display according to the present embodiment.

To manufacture the liquid crystal display 1, the partition walls 121 are first formed on the transparent substrate 12A, as shown in FIG. 4(a). Specifically, for example, a resin material is formed as a film on the transparent substrate 12A, the portions of the film that are superposed on the pixel areas Pr, Pg, Pb are opened, and the partition walls 121 are formed.

Next, droplets 21r, 22g, 23b of a material for forming the phase difference members 122r, 122g, 122b are discharged from droplet discharge heads 21 to 23 of a droplet discharge device, and the droplets are placed in the portions enclosed by the partition walls 121, as shown in FIG. 4(b). Here, a liquid-state forming material containing a macromolecular precursor having self-orientation properties is used as the material for forming the phase difference members 122r, 122g, 122b.

The birefringence and thickness of the phase difference members 122r, 122g, 122b are determined so that the liquid crystal layer 13 and the post-formation phase difference members 122r, 122g, 122b thus formed are used to bring the polarization state of each of the red light that has passed through the phase difference member 122r, the green light that has passed through the phase difference member 122g, and the blue light that has passed through the phase difference member 122b close to that of second linearly polarized light. The type of macromolecular precursor contained in the material used for forming each of the phase difference members 122r, 122g, 122b is selected on the basis of the determined birefringence. The discharge rate of the liquid-state forming material is adjusted for each formation area of the phase difference members 122r, 122g, 122b in accordance with the determined thickness.

Next, the macromolecular precursor contained in the applied liquid-state forming material is polymerized to form the phase difference members 122r, 122g, 122b, as shown in FIG. 4(c).

Droplets 24r, 25g, 26b of a material for forming the colorant parts 123r, 123g, 123b are then discharged from droplet discharge heads 24 to 26 of the droplet discharge device, and the droplets are placed in portions of the phase difference members 122r, 122g, 122b enclosed by the partition walls 121, as shown in FIG. 5(a). The forming material thus applied is then solidified by drying/baking, and the colorant parts 123r, 123g, 123b are formed, as shown in FIG. 5(b). Mutually varying the discharge rates of the material for forming the colorant parts 123r, 123g, 123b makes it possible to vary the thicknesses of the colorant parts 123r, 123g, 123b. The thickness of the liquid crystal layer 13 can be adjusted for each of the pixel areas Pr, Pg, Pb by using the differences in thickness between the colorant parts 123r, 123g, 123b.

ITO or another transparent electroconductive material is then formed as a continuous film over substantially the entire transparent substrate 12A across the colorant parts 123r, 123g, 123b, as shown in FIG. 5(c), and the shared electrode 124 is formed. The second orientation film 125 is then formed in a continuous formation on the shared electrode 124. A CF substrate 12 without the second polarizing plate 126 is thereby formed.

Separately from the formation of the CF substrate 12, an element substrate 11 without the first polarizing plate 116 is also formed as shown in FIG. 6(a). Specifically, the TFTs 112, the wiring elements, the passivation films, and the like are formed on the transparent substrate 11A, and the element layer 111 is formed. Island-shaped pixel electrodes 113 are then formed on the element layer 111. The passivation film 114 is continuously formed on the circumferential edge parts of the pixel electrodes 113 and in portions between the pixel electrodes 113. For example, an inorganic material (e.g., silicon oxide) is formed as a film in a continuous formation over substantially the entire transparent substrate 11A. The film is patterned and the passivation film 114 is obtained by exposing the portions (central parts) of the pixel electrodes 113 superposed on the pixel areas Pr, Pg, Pb. The first orientation film 115 is then formed in a continuous formation over substantially the entire transparent substrate 11A, covering the pixel electrodes 113 and the passivation film 114. The element substrate 11 can be formed by the appropriate use of known forming materials and methods.

Next, the element substrate 11 without the first polarizing plate 116, and the CF substrate 12 without the second polarizing plate 126 are placed opposite each other so that the pixel electrodes 113 and the shared electrode 124 are disposed inside, as shown in FIG. 6(b). The circumferential edge parts of the element substrate 11 and the CF substrate 12 are bonded together while the element substrate 11 and the CF substrate 12 are aligned with each other, and a liquid crystal material is encapsulated between the element substrate 11 and the CF substrate 12 to seal off the liquid crystal layer 13. The liquid crystal display 1 is obtained by affixing the first polarizing plate 116 to the exterior of the transparent substrate 11A, affixing the second polarizing plate 126 to the exterior of the transparent substrate 12A, and other similar steps.

A liquid crystal display capable of providing high-quality images can be manufactured by a method of manufacturing a liquid crystal display such as the one described above. The phase difference members 122r, 122g, 122b and the colorant parts 123r, 123g, 123b are formed as patterns by a droplet discharge method, allowing the type and discharged rate of the forming materials to be readily varied for the plurality of pixel areas Pr, Pg, Pb, and allowing the CF substrate 12 to be formed at a low cost and with high efficiency.

Partition walls 121 for enclosing each of the plurality of pixel areas Pr, Pg, Pb are formed, and a material for forming the phase difference members, as well as a material for forming the colorant parts, are discharged inside the openings of the partition walls 121. The relative positions of the colorant parts 123r, 123g, 123b and the phase difference members 122r, 122g, 122b can therefore be controlled to a high degree of precision. The element substrate 11 can also be manufactured in the same manner as an element substrate (for example, an active matrix substrate) used in an ordinary liquid crystal display, thereby dispensing with the need for processing devices not used in the manufacture of ordinary element substrates, and making it possible to reduce manufacturing costs. According to the manufacturing method of the present embodiment as described above, a liquid crystal display capable of yielding high-quality images can thus be manufactured at a low cost and with high efficiency.

It should be noted that the technical scope of the present invention is not limited to the foregoing embodiments. Various modifications are possible within the scope of the present invention without departing from the main idea thereof. The liquid crystal layer 13 may have an orientation other than a VA orientation or other TN orientation, and may be driven by a horizontal electric field. In a case where the orientation or the driving method of the liquid crystal layer is varied, the arrangement of the electrodes, the characteristics of the orientation film, the characteristics of the polarizing plate, and other aspects may be varied as desired. The liquid crystal display may also be a reflective or a semi-transmissive/semi-reflective liquid crystal display, rather than a transmissive liquid crystal display.

The phase difference members may be formed, for example, by forming an orientation film on the transparent substrate, and polymerizing the macromolecular precursor in a state where the macromolecular precursor has been oriented by the orientation film. The phase difference members may be provided to the light-receiving side of the second polarizing plate 126. For example, the colorant parts may be provided closer to the transparent substrate than to the phase difference members. The thicknesses of the colorant parts 123r, 123g, 123b may be varied, and the thickness of the liquid crystal layer 13 may be adjusted for each of the pixel areas Pr, Pg, Pb by using the differences in thickness. The thickness of the liquid crystal layer 13 may also be kept substantially uniform in the pixel areas Pr, Pg, Pb.

What is claimed is:

1. A liquid crystal display comprising:
a liquid crystal layer;
a plurality of colorant parts disposed at a position of incidence of light that has passed through the liquid crystal layer, the parts being disposed so as to be divided for each of a plurality of pixel areas, and having mutually different wavelengths for transmitted light;
a polarizing layer disposed on the light-emitting side of the liquid crystal layer; and
a plurality of phase difference members disposed on the light-admitting side of the polarizing layer and disposed so as to be divided for each of the plurality of pixel areas;
wherein, with each of the plurality of phase difference members, at least one of birefringence and thickness is varied for the plurality of phase difference members to adjust the retardation value so that, of the light that is incident on the polarizing layer, the polarization state of light whose wavelength allows the light to be transmitted by the colorant parts that correspond to the phase difference members is brought closer to that of linearly polarized light that oscillates in a designated direction.

2. The liquid crystal display according to claim 1, wherein
partition walls for annularly enclosing each of the plurality of pixel areas are provided between the plurality of colorant parts, and the plurality of phase difference members is disposed so as to be divided in the plurality of pixel areas enclosed by the partition walls.

3. The liquid crystal display according to claim 2, wherein
the plurality of colorant parts and the plurality of phase difference members are formed by a droplet discharge method.

4. The liquid crystal display according to claim 1, wherein
the thickness of the plurality of phase difference members varies with the phase difference members, and the thickness of the liquid crystal layer is adjusted for each of the plurality of pixel areas by using the differences in thickness between the plurality of phase difference members.

5. A method of manufacturing a liquid crystal display having a liquid crystal layer sandwiched between a first substrate and a second substrate, a polarizing layer provided on the light-emitting side of the liquid crystal layer, and a plurality of pixel areas for emitting light of different wavelengths, the method of manufacturing a liquid crystal display comprising:
a step for forming the first substrate;
a step for forming the second substrate; and
a step for bonding the first substrate and the second substrate together and sealing the liquid crystal layer between the first substrate and the second substrate;
wherein the step for forming the second substrate includes a step for forming partition walls for annularly enclosing each of the plurality of pixel areas on the substrate, a step for forming a plurality of colorant parts for which the wavelengths of transmitted light are different from each other by a droplet discharge method in each of the plurality of pixel areas enclosed by the partition walls, and a step for discharging a liquid material for forming phase difference members by the droplet discharge method in each of the plurality of pixel areas enclosed by the partition walls and varying at least one of the discharge rate and the material for forming phase difference members in the plurality of pixel areas to form a plurality of phase difference members having mutually different retardation values; and
wherein the retardation values of the plurality of phase difference members are adjusted in the step for forming the phase difference members so that, of the light that is incident on the polarizing layer, the polarization state of light whose wavelength allows the light to be transmitted by the colorant parts that correspond to the phase difference members is brought closer to that of linearly polarized light that oscillates in a designated direction.
